(19) United States
(12) Patent Application Publication
(10) Pub. No.: US 2025/0308404 A1
(43) Pub. Date: Oct. 2, 2025

(54) POTTY-TRAINING AID WITH FLAVORED GUMMY SNACKS

(71) Applicant: Althea Felecia Heron, Tampa, FL (US)

(72) Inventor: Althea Felecia Heron, Tampa, FL (US)

(21) Appl. No.: 19/094,177

(22) Filed: Mar. 28, 2025

Related U.S. Application Data
(60) Provisional application No. 63/571,009, filed on Mar. 28, 2024.

(51) Int. Cl. G09B 19/00; G09B 19/24

(52) U.S. Cl. CPC G09B 19/0076; G09B 19/24

(57) ABSTRACT

The present invention is directed towards various flavored gummy fruit snacks in shapes of a potty (toilet), toilet paper, soap, star and poop, for potty training toddlers. Gummies will be packaged in mini pouches that feature illustrations of animated children on the toilet, all appropriately dressed. The main pouch will feature an illustration of an animated child on the toilet appropriately dressed. This product will be the first of its kind in the market for potty training.

### CROSS REFERENCE TO RELATED APPLICATION

This application claims the benefit of priority of U.S. provisional application No. 63/571,009, filed Mar. 28, 2024, the contents of which are herein incorporated by reference.

### BACKGROUND OF THE INVENTION

Potty training is a critical milestone in a child's development, marking the transition from diapers to independence. Despite its importance, this process often proves challenging for parents and caregivers, who must navigate a complex web of physical, emotional, and psychological challenges. The current state-of-the-art approaches to potty training typically rely on a combination of rewards, punishments, and repetition, yet these methods frequently fall short in encouraging children to adopt the desired behavior.

One of the primary disadvantages of conventional potty-training methods is their reliance on abstract concepts such as “good” and “bad,” which can be confusing for young children. Moreover, many products and systems available on the market focus solely on physical aspects, such as toilet seats and training pants, without addressing the emotional and psychological needs of the child. This limited approach often leads to frustration and disappointment, as children struggle to grasp the connection between their actions and the desired outcome.

The objectives of potty training are multifaceted, involving not only the elimination of soiling but also the development of self-awareness, self-regulation, and social skills. However, current methods frequently fail to adequately address these complexities, resulting in a fragmented and often ineffective approach to potty training. The need for a comprehensive and engaging system that acknowledges the child's emotional and psychological needs is therefore pressing.

The present invention is directed at a novel and innovative solution that addresses the shortcomings of traditional potty-training methods. By leveraging the power of rewards, fun, and creativity, this invention seeks to revolutionize the potty-training process and empower children with the skills and confidence they need to excel in this critical area of development.

### SUMMARY OF THE INVENTION

The present invention is a novel potty-training aid comprising flavored gummy fruit snacks in various shapes, including but not limited to: a potty (toilet), toilet paper, soap, star, and poop. This invention solves the problem of making potty training a fun and engaging experience for toddlers by leveraging their natural affinity for treats and colorful designs.

The preferred embodiment of this invention features a main pouch with an illustration of an animated child on the toilet, appropriately dressed. The main pouch contains multiple mini pouches with gummies packaged inside. Each mini-pouch features illustrations of animated children on the toilets, all appropriately dressed, on the outside, and each mini pouch contains multiple flavored gummy fruit snacks in various shapes as described above. The flavored gummy fruit snacks, together with the associated packaging, provides a visually appealing and entertaining experience for the child, and also serves as a tangible representation of the potty-training process.

The present invention encourages toddlers to use the potty by associating it with a rewarding and enjoyable experience, provides a fun and engaging way to learn about potty training, making the process less intimidating and more accessible, and offers a unique and creative approach to potty-training that sets it apart from traditional methods. In addition, the present invention can be used in conjunction with other potty-training aids or as a standalone product.

These and other features, aspects and advantages of the present invention will become better understood with reference to the following drawings, description and claims.

### BRIEF DESCRIPTION OF THE DRAWINGS

FIG. 1 depicts a perspective view showing the main pouch of the present invention together with various mini pouches and various individual gummies in accordance with a preferred embodiment of the present invention;

FIG. 2 depicts a close-up view of certain individual gummies that would be stored within the mini pouches;

FIG. 3 depicts exemplary text that may appear on the back side of the main pouch;

FIG. 4 depicts exemplary images that may appear on the front side of the main pouch;

FIG. 5 depicts exemplary images that may appear on the mini pouches within the main pouch;

FIG. 6 depicts enlarged exemplary images that may appear on the mini pouches within the main pouch; and

FIG. 7 depicts enlarged exemplary images that may appear on the mini pouches within the main pouch.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As stated above, there are many challenges involved in potty training a toddler. The present invention is directed at solving these and other problems associated with conventional products and methods for potty training toddlers.

The present invention is a novel potty-training aid designed to make the process of learning to use the toilet more enjoyable and engaging for toddlers. The invention comprises a main pouch and multiple mini pouches, each containing flavored gummy fruit snacks in various shapes. The flavored gummy fruit snacks serve as a reward incentive for every time the child uses the potty, so it encourages them to keep using the potty properly. The more they use it the better, as practice makes perfect.

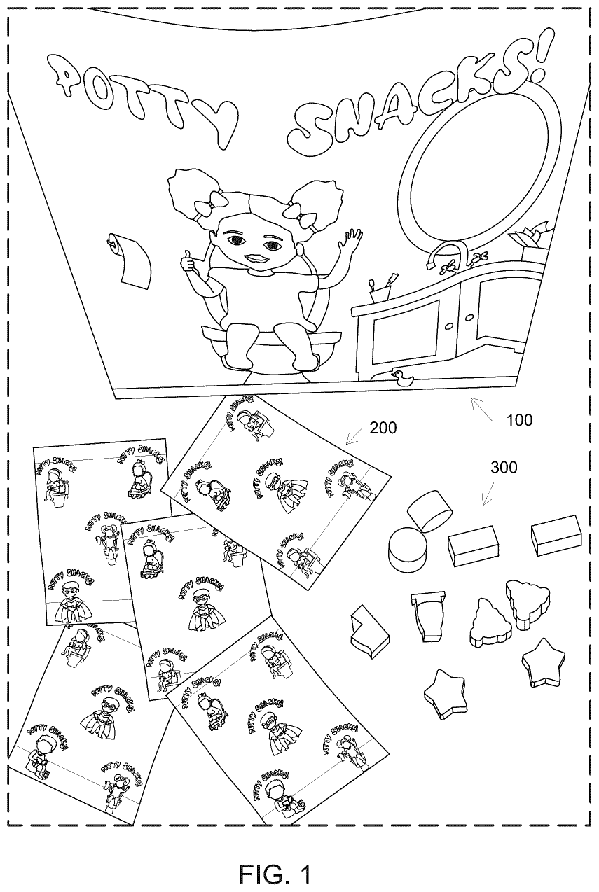

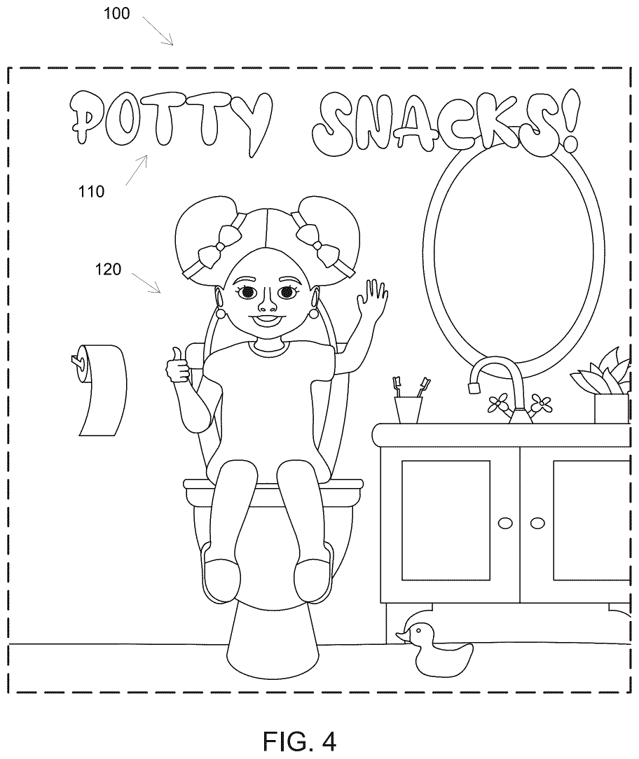

FIG. 1: This figure depicts the main pouch 100, which is designed to hold multiple mini-pouches 200 containing flavored gummy snacks 300 as rewards for successful potty-training. The main pouch 100 has an illustration of a child 120 on the toilet, serving as a visual representation of the potty-training process under the Potty Snacks title 110 (see FIG. 4).

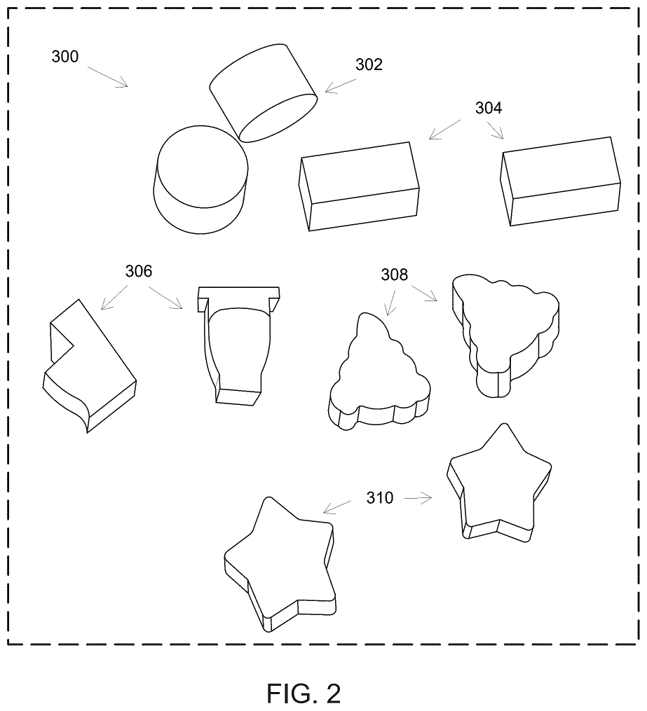

FIG. 2: This figure illustrates the various flavored gummy snacks 300 that are within the mine pouches 200. The gummy snacks come in various shapes (e.g., potty (306), toilet paper (302), soap (304), star (310), and poop (308). These shapes are designed to aid children in understanding the potty-training process and associating it with the rewards provided by the invention. The various flavors and colors could be used to differentiate between different rewards, making the experience more engaging and enjoyable for children. Other shaped gummy snacks could also be included as a matter of design choice.

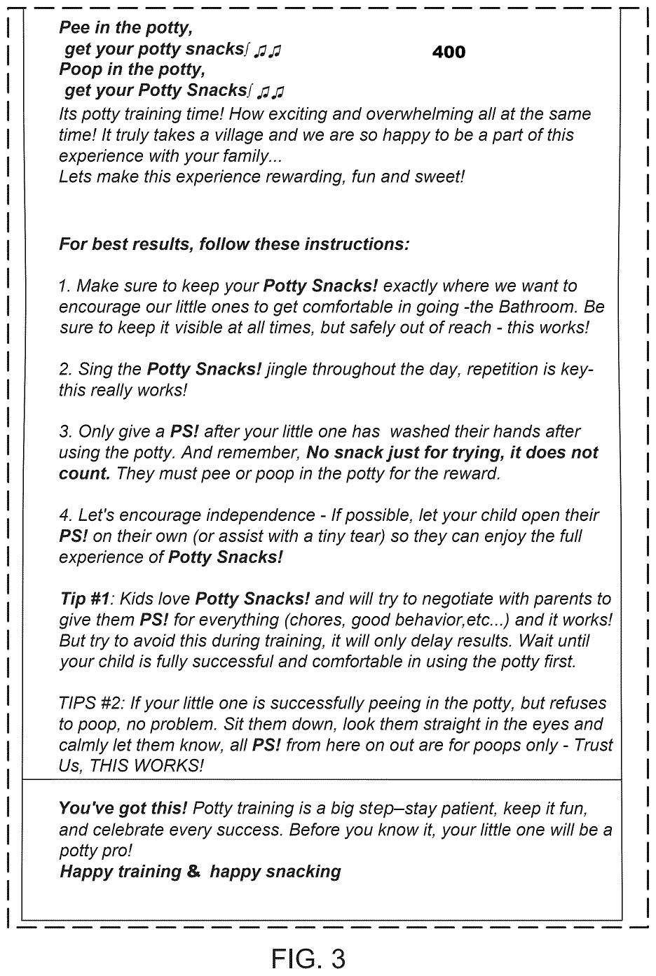

FIG. 3: This figure depicts exemplary text that may appear on the back side of the main pouch 100 to describe the gummy fruit snack reward system of the present invention.

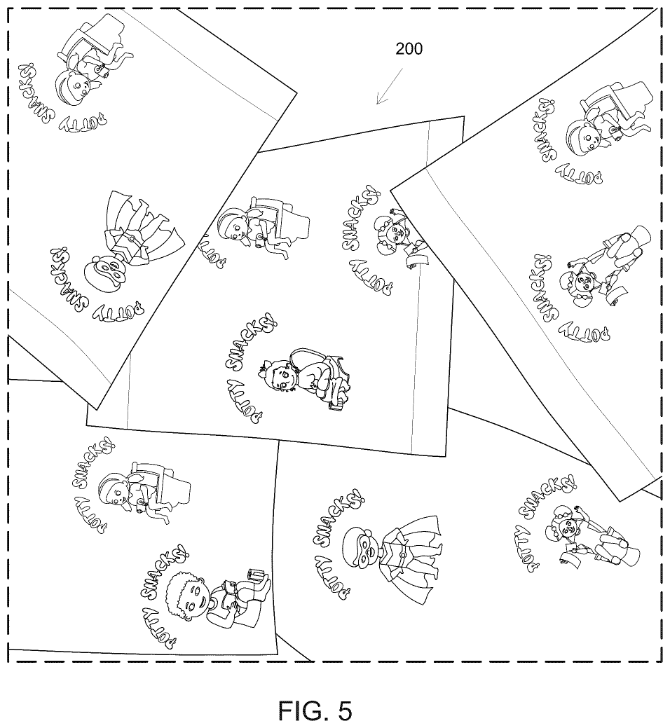

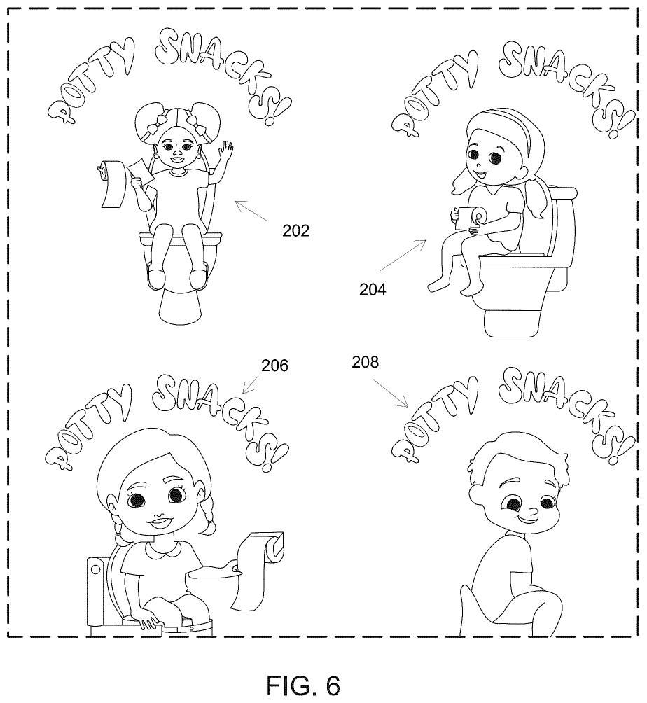

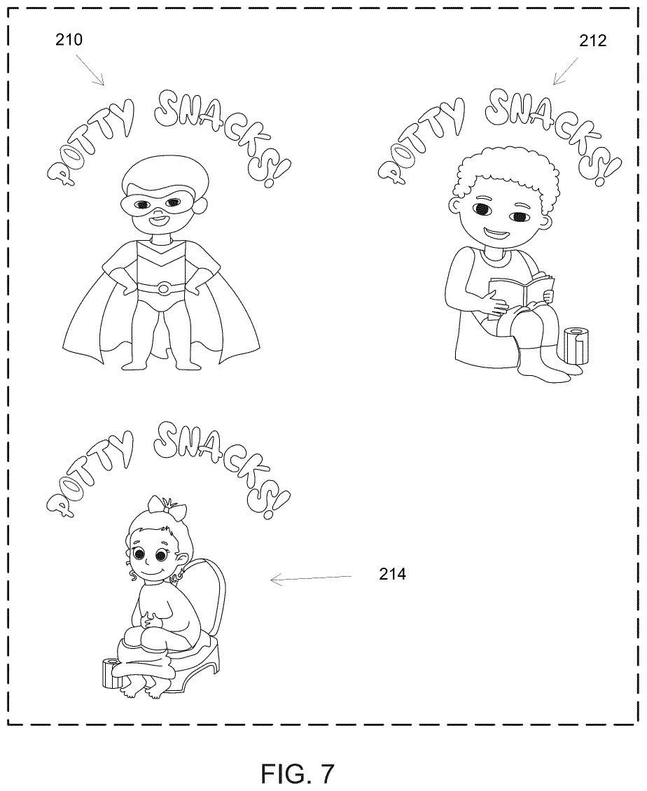

FIG. 5 depicts the mini pouches 200 that are stored within the main pouch 100. FIGS. 6 and 7 depict exemplary images 202, 204, 206, 208210, 212, and 214) that may appear on the mini pouches. Other images are also contemplated as a matter of design choice.

As described herein, and as seen in FIGS. 1-7 hereto, in a preferred embodiment the present invention comprises the following primary components:

### Main Pouch 100

The main pouch 100 is a child-friendly container made of a soft, flexible material that can be easily opened and closed by a parent or caregiver. The front of the main pouch features an illustration of an animated child 120 on the toilet, appropriately dressed, which serves as a visual representation of the potty-training process.

### Mini-Pouches 200

The mini-pouches 200 are small, individual containers and can be made of the same material as the main pouch. Different materials could be used for one or both as a matter of application specific design choice. Each mini pouch contains one or more gummy snacks 300, which come in specific shapes or designs related to potty training, such as a toilet 306, toilet paper 302, soap 304, star 310, or poop 308, to name a few. The mini pouches can contain multiple gummies of the same or different shape and color as a matter of design choice. The mini pouches are designed to be easily opened and closed by the child or caregiver, allowing access to the gummy snacks inside.

### Flavored Gummy Snacks 300

The flavored gummy snacks 300 come in different shapes and colors and are designed to aid in potty training. The shapes include but are not limited to: a potty (toilet) 306, toilet paper 302, soap 304, star 310, and poop 308. These shapes can help aid in potty training by providing a visual representation of the process. For example, the potty shape can serve as a reminder for the child to use the toilet correctly. The toilet paper shape can help children understand that wiping themselves after using the toilet is an important part of the process. The soap shape can be used to teach children about hygiene and cleanliness during potty training. The star shape can provide a sense of accomplishment and motivation for the child as they progress in their potty-training journey. Finally, the poop shape can help children understand that everyone has bowel movements and it's a normal part of life. The use of these (and other) shapes can also help to make potty training more engaging and enjoyable for children. For example, children may be more excited to receive a gummy snack in the shape of a toilet than a plain gummy snack.

The use of different colors in the flavored snacks may also be helpful for the training process. For example, the gummy snack in the shape of a toilet could be green to represent “clean” or “fresh”, while the one in the shape of poop could be brown to represent the natural color of stool. This visual association can help children better understand the concept of using the toilet and what it means to use it correctly. Additionally, the different colors can make the process more engaging and fun for children, as they learn to associate certain colors with specific tasks or outcomes.

### Operation

The operation of the present invention is as follows. A parent or caregiver introduces the main pouch and mini pouches to a toddler as part of the potty-training process. When the child successfully uses the toilet, they receive a reward in the form of one or more flavored gummy fruit snacks from one of the mini pouches. The child can then associate the use of the toilet with the reward, encouraging them to continue using the toilet correctly.

### Advantages

The present invention offers several advantages over traditional potty-training methods. First, the use of flavored gummy fruit snacks as rewards provides a more engaging and enjoyable experience for children, making the process of learning to use the toilet more fun and exciting. Second, the various shapes and designs and colors on the snacks, the main pouch, and mini pouches serve as a visual reminder of the potty-training process, helping children to better understand what is expected of them.

In addition, the invention provides a convenient and easy-to-use system for parents or caregivers, who can simply open and close the main pouch and mini pouches as needed. This reduces the stress and frustration often associated with potty training, allowing both children and adults to focus on the learning process.

Overall, the present invention is a novel and innovative approach to potty training that combines fun, engagement, and rewards to help toddlers learn this important skill. The product will be the first of its kind on the market. It is a fun rewarding approach to potty training. The mini-individual pouches given every time the child uses the potty are in small portions. The custom original shapes are fun, consisting of everything typically used in potty training. In addition, the present invention may also be accompanied by various complementary products, such as a children's story book, potty training watches; and/or a toy or doll (to name a few). Other complementary products could be included as a matter of choice.

For the best results, the caregiver should make sure to keep the product in an area that will help encourage our little ones to get comfortable in going the bathroom. Be sure to always keep it visible, but safely out of reach-this works!

Another aid is to sing the Potty Snacks! song/jingle throughout the day—this works!

Caregivers should only give a snack after your little one washes their hands after peeing or pooping in the potty. No snacks just for trying, it does not count. They must pee or poop in the potty for the reward.

If possible or with a little tear of assistance, allow your little one to open their snacks on their own, so they feel independent and really enjoy the full experience of the product.

Kids love Potty Snacks! and will try to convince their parents to give them one for every good deed (chores, good behavior, etc.) and it works. But parents should try to avoid this during training as it will only delay results. Wait until your child is fully successful and comfortable in using the potty first.

If your little one is successfully peeing in the potty, but refuses to poop in the potty, no problem. Sit them down, look them straight in the eyes and let them know, all snacks from here on out are for poops only. THIS WORKS!

It should be understood, of course, that the foregoing relates to exemplary embodiments of the invention and that modifications may be made without departing from the spirit and scope of the invention as set forth in the following claims.

What is claimed is:

1. A potty training aid comprising: a main pouch having an illustration of an child on a toilet, said main pouch containing multiple mini-pouches; each mini-pouch containing one or more flavored gummy fruit snacks in various shapes, including but not limited to: a potty (toilet), toilet paper, soap, star, and poop;
wherein each shape is designed to educate children about the potty training process; and wherein the combination of the main pouch and mini-pouches provides an engaging and rewarding experience for toddlers to use the potty.

2. The potty-training aid according to claim 1, wherein said main pouch and mini-pouches are made of child-friendly material.

3. The potty-training aid according to claim 1, further comprising instructions on the main pouch for parents or caregivers on how to use the aid in conjunction with traditional potty-training methods.

4. The potty-training aid according to claim 1, wherein said flavored gummy fruit snacks are sugar-free and/or organic.

5. The potty-training aid according to claim 1, wherein said various shapes are designed to be used in a specific order or sequence, thereby guiding the child through the potty-training process.

6. A method for potty training a toddler, comprising:
a) providing a potty-training aid including flavored gummy fruit snacks in various shapes, including but not limited to: a potty (toilet), toilet paper, soap, star, and poop;
b) associating the use of the potty with the reward of consuming said flavored gummy fruit snacks;
c) repeating steps a) and b) multiple times until the toddler becomes accustomed to using the potty; and
d) providing encouragement and positive reinforcement to the toddler throughout the potty-training process.

7. A method according to claim 6, wherein the step of providing a reward comprises providing a flavored gummy snack in a shape that is visually distinct from other shapes provided.

8. A method according to claim 6, wherein the step of associating the use of the toilet with the reward comprises verbally encouraging the child to use the toilet correctly and providing the reward after successful completion of the task.

9. A method according to claim 6, wherein the step of repeating the process multiple times until the child becomes accustomed to using the toilet comprises gradually increasing the frequency and duration of the training sessions over time.

10. A method according to claim 6, wherein the step of providing encouragement and positive reinforcement comprises praising the child for their efforts and providing rewards in a consistent and predictable manner.
